(19) United States
(12) Patent Application Publication
(10) Pub. No.: US 2007/0028186 A1
(43) Pub. Date: Feb. 1, 2007

(54) Digital image processing apparatus having efficient input function and method of controlling the same

(75) Inventors: Se-hyun Park, Seoul (KR); Chang-beom Shin, Seoul (KR); Eun-kyung Lee, Seoul (KR); Na-ri Choi, Seoul (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/324,905

(22) Filed: Jan. 4, 2006

(30) Foreign Application Priority Data
Jul. 26, 2005 (KR) 10-2005-0067834

(51) Int. Cl. G06F 17/00

(52) U.S. Cl. 715/810

(57) ABSTRACT

Provided is a digital image processing apparatus including: an array of a plurality of input buttons; and a display panel which displays icons respectively corresponding to the input buttons at positions respectively corresponding to positions of the input buttons, and a method of controlling the apparatus.

### BACKGROUND OF THE INVENTION

This application claims the priority of Korean Patent Application No. 2005-0067834, filed on Jul. 26, 2005, in the Korean Intellectual Property Office, the disclosure of which is incorporated herein in its entirety by reference.

1. Field of the Invention

The present invention relates to a digital image processing apparatus and a method of controlling the same, and more particularly, to a digital image processing apparatus that includes a display panel and an array of a plurality of input buttons, and a method of controlling the apparatus.

2. Description of the Related Art

A conventional digital image processing apparatus is disclosed in U.S. Patent Publication No. 20040257459 entitled “Method of Controlling Portable. Digital Apparatus Where Folder Icons Move”, filed by the present applicant in 2004. Such a conventional digital image processing apparatus includes a display panel and a plurality of input buttons.

### SUMMARY OF THE INVENTION

In the digital image processing apparatus described above, each of the input buttons has only one specific input function. Hence, a number of input buttons must be manipulated to execute one of a variety of menus. Furthermore, since direction buttons are used to select icons displayed on a display panel, a user cannot quickly select a desired icon. The present invention provides a solution to these problems. The present invention provides a digital image processing apparatus which can efficiently reduce the number of times that a user has to manipulate input buttons and enables the user to select a desired icon directly and quickly.

According to an aspect of the present invention, there is provided a digital image processing apparatus including: an array of input buttons; and a display panel which displays icons corresponding to the array of input buttons at positions corresponding to positions of the input buttons.

According to another aspect of the present invention, there is provided a method of controlling a digital image processing apparatus that includes a display panel and an array of input buttons. In the method, icons corresponding to the input buttons are displayed at positions corresponding to positions of the input buttons.

According to the digital image processing apparatus and the method of controlling the same, a plurality of icons respectively corresponding to a plurality of input buttons are displayed at positions corresponding to those of the input buttons. Therefore, each of the input buttons can perform functions of a plurality of icons. As a result, the number of times that a user has to manipulate the input buttons can be efficiently reduced, and the user can select a desired icon directly and quickly.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a digital image processing apparatus in the form of a digital camera which displays four icons at positions respectively corresponding to those of four input buttons according to an embodiment of the present invention;

FIG. 2 is a schematic block diagram of the entire configuration of the digital camera 1 of FIG. 1 according to an embodiment of the present invention;

FIG. 3 is a flowchart illustrating a main control algorithm of a digital camera processor (DCP) illustrated in FIG. 2 according to another embodiment of the present invention;

FIG. 4 illustrates an icon corresponding to an input button positioned in the leftmost column and in the middle row of an array of nine input buttons of the digital camera in a state illustrated in FIG. 1 and activated when a user's finger touches the input button according to an embodiment of the present invention;

FIG. 5 shows an icon corresponding to an input button positioned in the leftmost column and in the bottom row of the array of nine input buttons of the digital camera in the state illustrated in FIG. 1 and activated when the user's finger touches the input button according to an embodiment of the present invention;

FIG. 6A illustrates an icon corresponding to an input button positioned in the rightmost column and in the bottom row of the array of nine input buttons of the digital camera in the state illustrated in FIG. 1 and activated when the user's finger touches the input button according to an embodiment of the present invention;

FIG. 6B illustrates nine icons displayed at positions respectively corresponding to those of the nine input buttons when the user's finger, which is in touch with the input button as illustrated in FIG. 6A, presses the input button to operate the activated icon according to an embodiment of the present invention;

FIG. 7 illustrates an icon corresponding to an input button positioned in the rightmost column and in the middle row of the array of nine input buttons of the digital camera in the state illustrated in FIG. 1 and activated when the user's finger touches the input button according to an embodiment of the present invention;

FIG. 8A illustrates nine icons displayed at positions respectively corresponding to those of the nine input buttons when the user presses an input button positioned in the middle column and middle row of the array of nine input buttons of the digital camera in the state shown in FIG. 1 according to an embodiment of the present invention;

FIG. 8B illustrates an icon corresponding to an input button positioned in the rightmost column and in the top row of the array of nine input buttons of the digital camera in a state illustrated in FIG. 8A and activated when the user's finger touches the input button according to an embodiment of the present invention;

FIG. 8C illustrates four icons displayed at positions respectively corresponding to those of four input buttons when the user's finger, which is in touch with the input button as illustrated in FIG. 8B, presses the input button to operate the activated icon according to an embodiment of the present invention;

FIG. 9A illustrates two icons displayed at positions respectively corresponding to those of two input buttons when an operating mode of the digital camera of FIG. 1 switches to a reproducing mode after a user manipulates mode buttons according to an embodiment of the present invention; and

FIG. 9B illustrates an icon corresponding to an input button positioned in the rightmost column and in the middle row of the array of nine input buttons of the digital camera in a state illustrated in FIG. 9A and activated when the user's finger touches the input button according to an embodiment of the present invention.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth therein; rather, these embodiments are provided so that this disclosure will be thorough and complete, and will fully convey the concept of the invention to those skilled in the art.

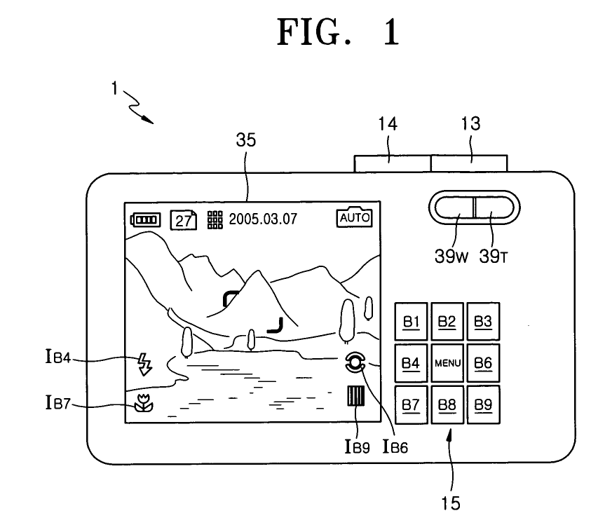

FIG. 1 illustrates a digital image processing apparatus in the form of a digital camera 1 according to an embodiment of the present invention. Referring to FIG. 1, four icons I_{B4}, I_{B6}, I_{B7}, and I_{B9} are displayed at positions corresponding to the four input buttons B4, B6, B7, and B9 of an array of nine input buttons 15. In FIG. 1, reference numeral 35 indicates a color LCD panel, reference numeral 13 indicates a shutter release button, reference numeral 14 indicates mode buttons for setting an operating mode, reference numeral 39_{W} indicates a wide-angle zoom button, and reference numeral 39_{T} indicates a telephoto zoom button.

Each of the array of nine input buttons 15 generates a first signal when touched by a user and generates a second signal when pressed by the user. More specifically, when a user's finger touches one of the array of nine input buttons 15, the first signal is generated by a touch sensor, and when one of the array of nine input buttons 15 is properly pressed, the second signal is generated.

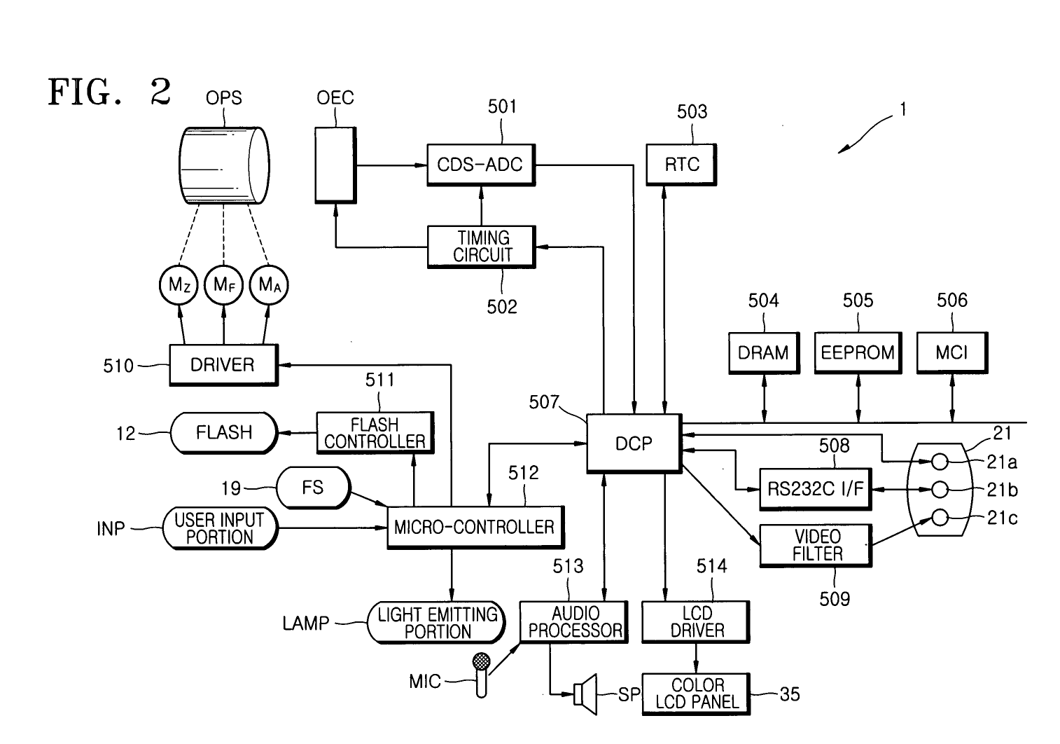

FIG. 2 is a schematic block diagram of the entire configuration of the digital camera 1 of FIG. 1 according to an embodiment of the present invention. The entire configuration and operation of the digital camera 1 of FIG. 1 will now be described with reference to FIGS. 1 and 2.

An optical system (OPS) including a lens unit and a filter unit optically processes light from a subject. The lens unit of the OPS includes a zoom lens, a focal lens, and a compensation lens.

When a user presses the wide-angle zoom button 39_{W} or the telephoto zoom button 39_{T} included in a user input portion (INP), a signal corresponding to the wide-angle zoom button 39_{W} or the telephoto zoom button 39_{T} is relayed to a micro-controller 512. The micro-controller 512 controls a driver 510, thereby running a zoom motor M_{Z}, which in turn, moves the zoom lens.

In an automatic focusing mode, a main controller built into a digital camera processor (DCP) 507 controls the driver 510 through the micro-controller 512, thereby driving a focus motor M_{F}. Accordingly, when the focal lens is moved, the position of the focal lens, for example, a number of driving steps of the focus motor M_{F}, having a largest high frequency component of an image signal is set. Reference numeral M_{A} indicates a motor for driving an aperture (not shown).

A photoelectric conversion unit (OEC) of a charge coupled device or a complementary metal oxide (CMOS) semiconductor converts light from the OPS into an analog electrical signal. Here, the DCP 507 controls a timing circuit 502 to control the operations of the OEC and a correlation-double-sampler-and-analog-to-digital converter (CDS-ADC) 501. The CDS-ADC 501 processes an analog signal from the OEC, eliminates high frequency noise therefrom, adjusts an amplitude thereof, and then converts the analog signal into a digital signal.

A real time clock (RTC) 503 provides time information to the DCP 507. The DCP 507 processes the digital signal from the CDS-ADC 501 and generates a digital image composed of luminance and chromaticity values.

A light emitting portion (LAMP) is operated by the micro-controller 512 in response to a control signal generated by the DCP 507 including the main controller. The light emitting portion (LAMP) includes a plurality of indicator lamps. The user input portion INP includes the shutter release button 13, the mode buttons 14, the wide-angle zoom button 39_{W}, the telephoto zoom button 39_{T}, and the array of nine input buttons 15

A dynamic random access memory (DRAM) 504 temporarily stores a digital image signal from the DCP 507. An electrically erasable and programmable read only memory (EEPROM) 505 stores algorithms and setting data. A user's memory card is inserted into or removed from a memory card interface 506. The digital image signal from the DCP 507 is input to an LCD driver 514, thereby displaying an image on the color LCD panel 35.

The digital image signal from the DCP 507 can be transmitted via a universal serial bus (USB) connector 21a or via an RS232C interface 508 and an RS232C connector 21b for serial communications. The digital image signal from the DCP 507 can also be transmitted via a video filter 509 and a video output unit 21c as a video signal.

An audio processor 513 can relay sound from a microphone MIC to the DCP 507 or to a speaker SP. In addition, the audio processor 513 can output an audio signal from the DCP 507 to the speaker SP. The micro-controller 512 controls the operation of a flash controller 511 in response to a signal from a flash-luminance sensor (not shown), thereby driving a flash 12.

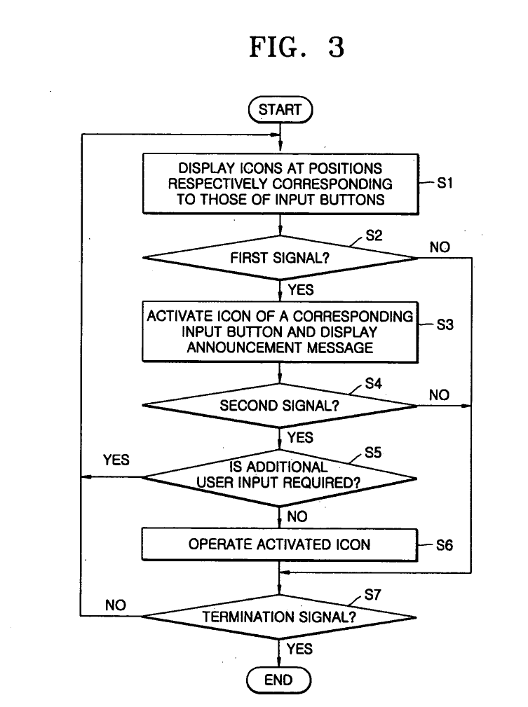

On the color LCD panel 35, the icons I_{B4}, I_{B6}, I_{B7}, and I_{B9}, which respectively correspond to the nine input buttons 15 included in the INP, are displayed at positions respectively corresponding to those of the four input buttons B4, B6, B7, and B9 of the array of nine input buttons 15. Therefore, each of the array of nine input buttons 15 included in the INP can perform functions of a plurality of icons. As a result, the number of times that a user has to manipulate the input buttons can be efficiently reduced, and the user can select a desired icon directly and quickly. This will be described in more detail with reference to FIGS. 3 through 9B.

In FIGS. 1 through 9B, like reference numerals denote like elements. A main control algorithm of the DCP 507 of FIG. 2 will now be described with reference to FIGS. 1 through 9B.

As described above, each of the nine input buttons 15 generates the first signal when touched by a user and generates the second signal when pressed by the user. More specifically, when a user's finger touches any one of the array of nine input buttons 15, the first signal is generated by a touch sensor, and when one of the nine input buttons 15 is properly pressed, the second signal is generated.

In operation S1 (FIG. 3), the DCP 507 controls the LCD driver 514 to display icons at positions respectively corresponding to those of input buttons. In a photographing mode of FIG. 1, the four icons I_{B4}, I_{B6}, I_{B7}, and I_{B9} are displayed at positions respectively corresponding to those of the four input buttons B4, B6, B7, and B9.

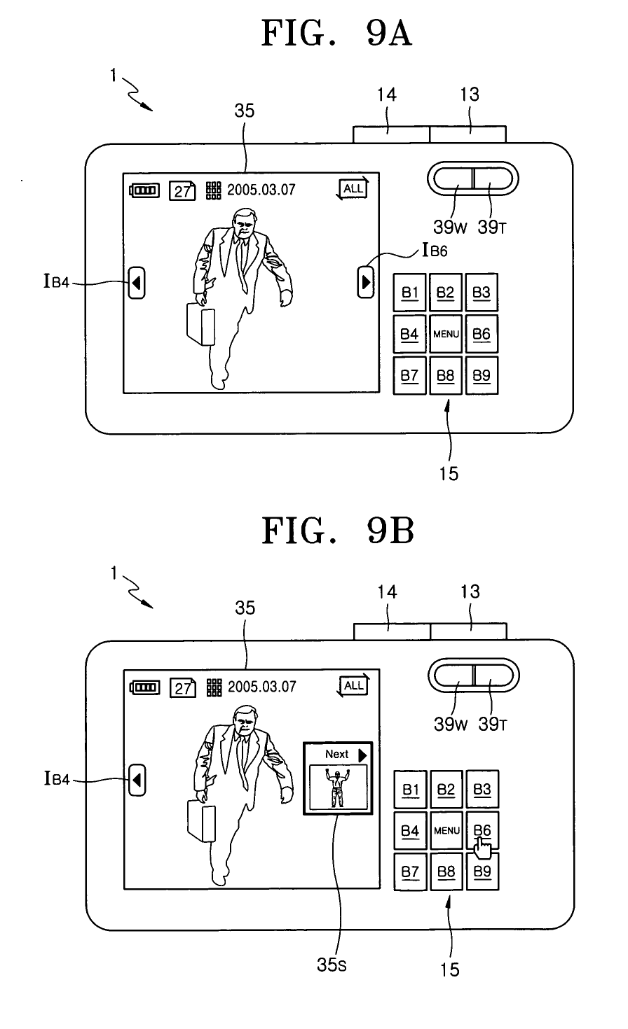

Referring to FIG. 9A, when the operating mode of the digital camera 1 of FIG. 1 switches to a reproducing mode after a user manipulates the mode buttons 14, the two icons I_{B4} and I_{B6} are displayed at positions respectively corresponding to those of the two input buttons B4 and B6.

In operations S2 and S3 (FIG. 3), when the user's finger touches any one of the array of nine input buttons 15, thereby generating the first signal (S2), the DCP 507 activates an icon of the touched input button and displays an announcement message (S3).

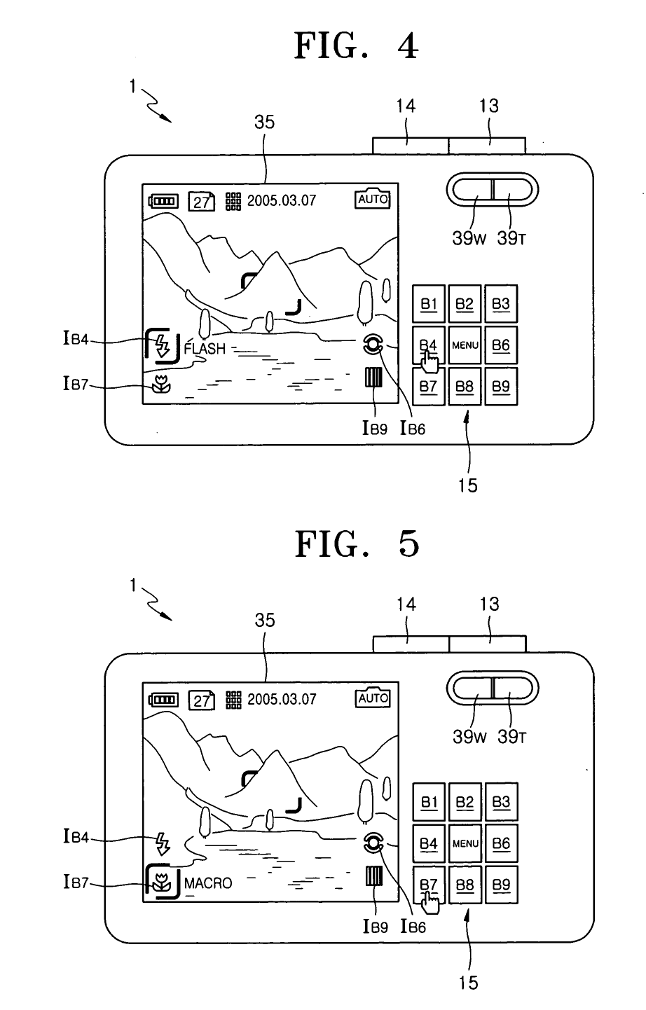

FIG. 4 illustrates the icon I_{B4} corresponding to the input button B4 positioned in the leftmost column and in the middle row of the array of nine input buttons 15 of the digital camera 1 in a state illustrated in FIG. 1 and activated when a user's finger touches the input button B4 according to an embodiment of the present invention. More specifically, when the first signal is generated by the input button B4 after the user's finger touches the input button B4 (S2), the DCP 507 activates the icon I_{B4} corresponding to the input button B4 and displays an announcement message “FLASH” showing what the activated icon I_{B4} represents (S3).

FIG. 5 illustrates the icon I_{B7} corresponding to the input button B7 positioned in the leftmost column and in the bottom row of the array of nine input buttons 15 of the digital camera 1 in the state illustrated in FIG. 1 and activated when the user's finger touches the input button B7 according to an embodiment of the present invention. More specifically, when the first signal is generated by the input button B7 after the user's finger touches the input button B7 (S2), the DCP 507 activates the icon I_{B7} corresponding to the input button B7 and displays an announcement message “MACRO” showing what the activated icon I_{B7} represents (S3).

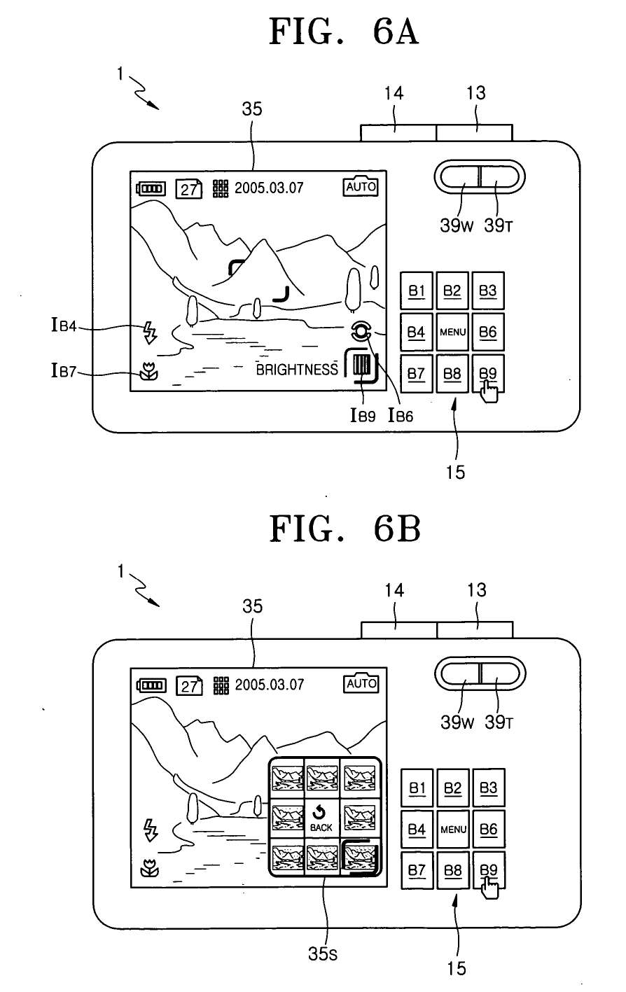

FIG. 6A illustrates the icon I_{B9} corresponding to the input button B9 positioned in the rightmost column and in the bottom row of the array of nine input buttons 15 of the digital camera 1 in the state illustrated in FIG. 1 and activated when the user's finger touches the input button B9 according to an embodiment of the present invention. More specifically, when the first signal is generated by the input button B9 after the user's finger touches the input button B9 (S2), the DCP 507 activates the icon I_{B9} corresponding to the input button B9 and displays an announcement message “BRIGHTNESS” showing what the activated icon I_{B9} represents (S3).

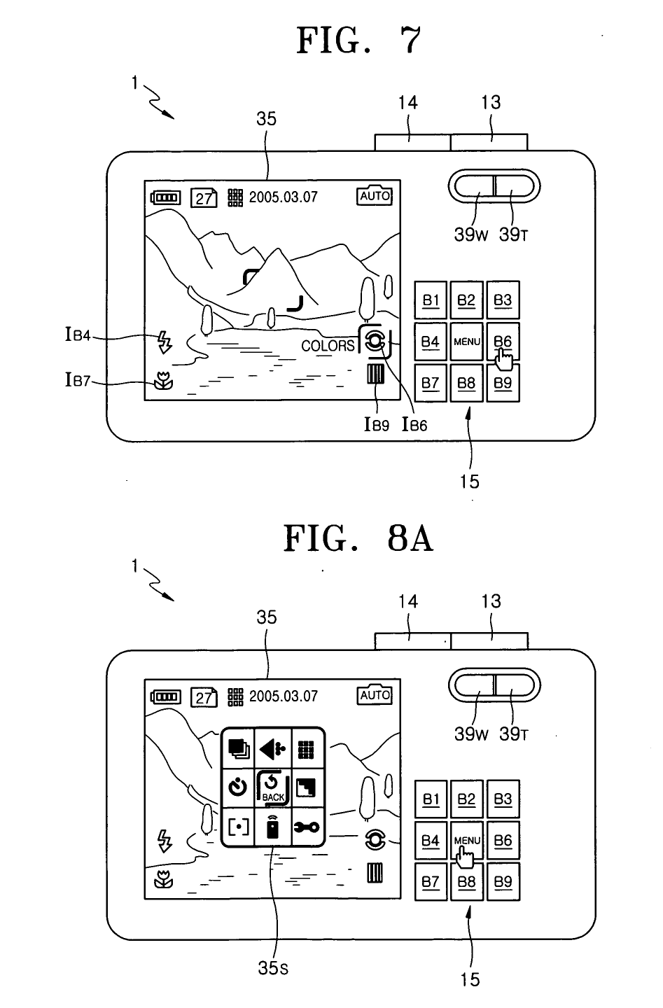

FIG. 7 illustrates the icon I_{B6} corresponding to the input button B6 positioned in the rightmost column and in the middle row of the array of nine input buttons 15 of the digital camera 1 in the state illustrated in FIG. 1 and activated when the user's finger touches the input button B6 according to an embodiment of the present invention. More specifically, when the first signal is generated by the input button B6 after the user's finger touches the input button B6 (S2), the DCP 507 activates the icon I_{B6} corresponding to the input button B6 and displays an announcement message “COLORS” showing what the activated icon I_{B6} represents (S3).

FIG. 9B illustrates the icon I_{B6} corresponding to the input button B6 positioned in the rightmost column and in the middle row of the array of nine input buttons 15 of the digital camera 1 in a reproducing mode illustrated in FIG. 9A and activated when the user's finger touches the input button B6 according to an embodiment of the present invention. More specifically, when the first signal is generated by the input button B6 after the user's finger touches the input button B6 (S2), the DCP 507 activates the icon I_{B6} corresponding to the input button B6 and displays an announcement message “Next” showing what the activated icon I_{B6} represents, and a reduced version of a following picture (S3). Here, when the input button B6 has been pressed (S4), the reduced picture i.e., the thumbnail picture is enlarged and displayed on the whole screen, and a new reduced picture is displayed (S6).

In operations S4 through S6, when the second signal is generated after the user presses any one of the array of nine input buttons 15 properly, the DCP 507 determines whether an additional input is required to operate an activated icon. If an additional input is required, the DCP 507 performs operations S1 through S4 again. If not, the DCP 507 operates the activated icon. For an additional user input, operation S1 is performed as follows.

Referring to FIG. 6B, when the user's finger, which is touching the input button B9 as illustrated in FIG. 6A, presses the input button B9 properly, nine icons included in a new icon window 35_{S} are displayed at positions respectively corresponding to those of the array of nine input buttons 15 to operate the activated icon I_{B9} of FIG. 6A. Here, the DCP 507 displays the main icons or the previously displayed icons again as depicted in FIG. 7 (S1) if operation of the activated icon has been completed.

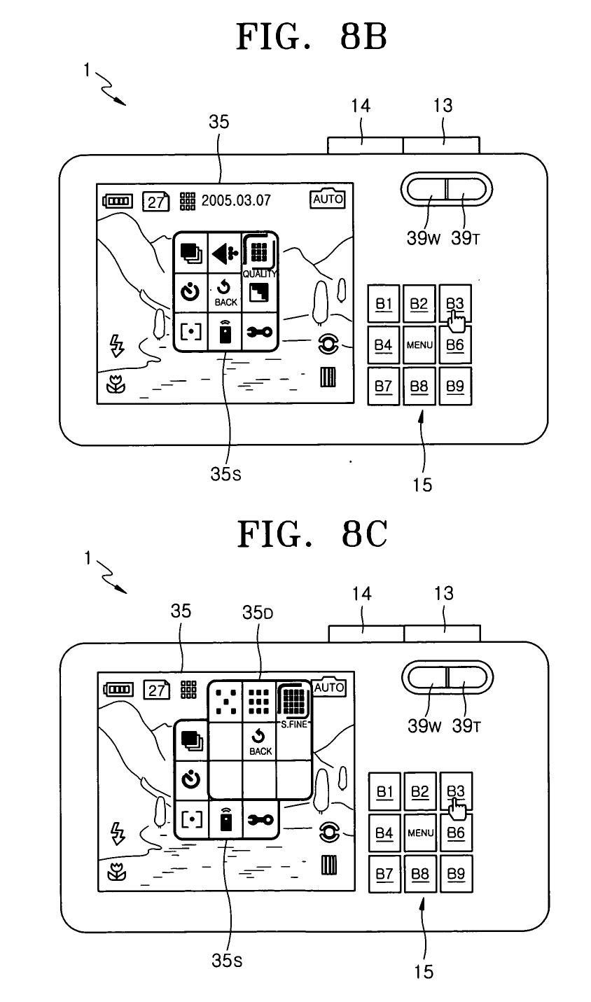

Referring to FIG. 8A, when the user presses an input button (MENU button) positioned in the middle row and middle column for the array of nine input buttons 15 of the digital camera 1 in the state illustrated in FIG. 1, the nine icons included in the icon window 35_{S} are displayed at the positions respectively corresponding to those of the array of the nine input buttons 15.

In response to the icon window 35_{S}, the input button (MENU button) positioned in the middle row and middle column of the array of nine input buttons 15 of the digital camera 1 has a BACK function for returning to higher-level icons. Therefore, when the user's finger in touch with the input button (MENU button) presses the input button (MENU button), the digital camera 1 returns to the state illustrated in FIG. 1.

FIG. 8B illustrates an icon corresponding to the input button B3 and activated when the user's finger touches the input button B3 positioned in the rightmost column and in the top row of the array of nine input buttons 15 of the digital camera 1 in a state illustrated in FIG. 8A.

Referring to FIG. 8C, when the user's finger, which is touching the input button B3 as illustrated in FIG. 8B, presses the input button B3, four icons included in a sub-icon window 35_{D} are displayed at positions respectively corresponding to those of the four input buttons B1, B2, B3, and MENU to operate the activated icon.

The icons of the sub-icon window 35_{D} are displayed together with the activated icon and at least some of the icons of the icon window 35_{S}. Accordingly, the user can immediately recognize the hierarchical structure of the sub-icon window 35_{D} currently activated in relation to the icon window 35_{S}.

In response to the sub-icon window 35_{D}, the input button (MENU button) positioned in the middle row and middle column of the array of nine input buttons 15 of the digital camera 1 has the BACK function for returning to higher-level icons. Therefore, when the user's finger, which is in touch with the input button (MENU button) as illustrated in FIG. 8C, presses the input button (MENU button), all the icons of the icon window 35_{S} are displayed. Here, a representative image of the main icon is changed to an image of the sub-icon which has been used for the setting.

Operations S1 through S6 are repeated until a termination signal is input from an external source (S7).

As described above, according to a digital image processing apparatus and a method of controlling the same, a plurality of icons respectively corresponding to a plurality of input buttons are displayed at positions respectively corresponding to those of the input buttons. Therefore, each of the input buttons can perform functions of a plurality of icons. As a result, the number of times that a user has to manipulate the input buttons can be efficiently reduced, and the user can select a desired icon directly and quickly.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A digital image processing apparatus comprising:
an array of input mechanisms disposed on the digital image processing apparatus;
a display panel which displays icons corresponding to the input mechanisms at positions respectively corresponding to positions of the input mechanisms disposed on the digital image processing apparatus; and
a data processing mechanism for sensing a signal sent by an input mechanism and for performing the function associated with the icon that corresponds to the input mechanism.

2. The apparatus of claim 1, wherein the input mechanisms are buttons and the signal is a first signal and a second signal, wherein the first signal is generated when a user touches any one of the input buttons, and the second signal is generated when the user presses any one of the input buttons.

3. The apparatus of claim 2, wherein the first signal is generated by a touch sensor.

4. The apparatus of claim 1, wherein each of the array of input mechanisms performs at least two different input functions.

5. The apparatus of claim 1, wherein the apparatus has user-selected modes of operation and at least some of the array of input mechanisms perform input functions in at least two of the different modes.

6. The apparatus of claim 1, wherein the array of input mechanisms includes input mechanisms selected from the group consisting of buttons, switches, levers, knobs, and touch sensors.

7. The apparatus of claim 1, wherein the array is disposed adjacent to the display panel.

8. The apparatus of claim 7, wherein the array is comprised of a total of nine buttons arranged in three rows of three buttons.

9. A method of controlling a digital image processing apparatus comprising a display panel and an array of input mechanisms, the method comprising:
displaying icons, on the display panel, corresponding to the input mechanisms at positions respectively corresponding to positions of the input mechanisms;
receiving a first signal generated by one of the input mechanisms and activating in response an icon corresponding to the input mechanism that generated the first signal; and
receiving a second signal generated by one of the input mechanisms and performing the function associated with the activated icon when a second signal is generated by one of the input mechanisms.

10. The method of claim 9, wherein the input mechanisms are buttons and a first signal is generated when a user touches any one of the input buttons, and a second signal is generated when the user presses any one of the input buttons.

11. The method of claim 9, wherein, in the activation of the icon, an announcement message showing what the activated icon represents is displayed.

12. The method of claim 9, wherein, in performing the function associated with the activated icon, when an additional input from the user is required, new icons respectively corresponding to the input mechanisms are displayed at positions respectively corresponding to the positions of the input mechanisms.

13. The method of claim 12, wherein the new icons includes an icon representing an input mechanism for returning the user to the previously displayed icons.

14. The method of claim 12, wherein, in performing the function associated with one of the new icons, the previously displayed icons are returned.

15. The method of claim 14, wherein, in returning the previously displayed icons, a representative image of one of the previously displayed icons is changed to an image of the one of the new icons.

16. The method of claim 12, wherein the new icons are displayed together with the activated icon and at least some of the previously displayed icons in a manner so that the hierarchical structure of the icons is displayed.

17. The method of claim 16, wherein the new icons include an icon representing an input mechanism for returning the user to the previously displayed icons in the hierarchy.

18. The method of claim 9, wherein the digital image processing apparatus is a camera and after the icon is activated in response to the first signal, a reduced version of a picture following a current picture is displayed on the display panel.

19. The method of claim 18, wherein, after the icon is pressed to generate the second signal, the reduced version is enlarged and displayed on the display panel, and a new reduced version of a picture following the enlarged picture is displayed on the display panel.

20. A method of controlling a camera comprising a display panel and an array of input mechanisms, the method comprising:
displaying icons corresponding to the input mechanisms at positions corresponding to positions of the input mechanisms;
receiving a first signal generated by an input mechanism;
activating an icon corresponding to the input mechanism that generated the first signal and displaying an announcement message illustrating the function the activated icon represents;
determining if additional information is required from the user;
displaying new icons, if additional information is required from the user, corresponding to the input mechanisms, at positions corresponding to the positions of the input mechanisms; and
receiving a second signal generated by one of the input mechanisms and performing the function associated with the activated icon.

21. The method of claim 20 wherein the input mechanisms are buttons.

22. The method of claim 21 wherein each button has a touch sensor.

23. The method of claim 20, wherein the camera has user-selected modes of operation and at least some of the array of input mechanisms perform input functions in at least two of the different modes.
